(19) United States
(12) Patent Application Publication
(10) Pub. No.: US 2024/0372169 A1
(43) Pub. Date: Nov. 7, 2024

(54) METHOD FOR RECOVERING WASTE LITHIUM BATTERY MATERIALS

(71) Applicants: GUANGDONG BRUNP RECYCLING TECHNOLOGY CO., LTD., Foshan, Guangdong (CN); HUNAN BRUNP RECYCLING TECHNOLOGY CO., LTD., Changsha, Hunan (CN); HUNAN BRUNP EV RECYCLING CO., LTD., Changsha, Hunan (CN)

(72) Inventors: Xingen Chen, Foshan, Guangdong (CN); Leijun Cao, Foshan, Guangdong (CN); Ran He, Foshan, Guangdong (CN); Liang Li, Foshan, Guangdong (CN); Honghui Tang, Foshan, Guangdong (CN); Changdong Li, Foshan, Guangdong (CN)

(21) Appl. No.: 18/689,070

(22) PCT Filed: Sep. 9, 2022
(86) PCT No.: PCT/CN2022/118012

§ 371 Date: Mar. 5, 2024

(30) Foreign Application Priority Data
Jun. 29, 2022 (CN) 202210748047.0

(51) Int. Cl. H01M 10/54; C22B 3/00; C22B 3/22; C22B 3/44; C22B 7/00; C22B 15/00; C22B 21/00; C22B 26/12; C22B 47/00

(52) U.S. Cl. CPC H01M 10/54; C22B 3/22; C22B 3/44; C22B 7/001; C22B 7/008; C22B 15/0078; C22B 15/0086; C22B 15/0089; C22B 21/0023; C22B 23/0446; C22B 23/0461; C22B 26/12; C22B 47/00

(57) ABSTRACT

A method for recovering waste lithium battery materials, comprising: (1) performing cell-disassembling on a waste lithium battery to obtain battery powder, ammonia leaching the battery powder to obtain a mixture, and subjecting the mixture to solid-liquid separation to obtain a leached solution and a filter residue; (2) adding a fluorine-phosphorus precipitating agent to the leached solution to obtain a mixture, and subjecting the mixture to solid-liquid separation to obtain a filtrate; (3) subjecting the filtrate to ammonia distillation, subjecting a mixture obtained to solid-liquid separation to obtain a filtrate and a filter residue containing basic copper carbonate and lithium carbonate; (4) washing the filter residue with water, and separating the basic copper carbonate to obtain a washing water; (5) reducing and calcining the filter residue, washing the residue, adding the washing water to the residue to collect lithium by water leaching, and filtering a mixture to obtain a filtrate.

### FIELD

The present invention belongs to the technical field of recovery of lithium ion battery, and in particular relates to a method for recovering waste lithium battery materials.

### BACKGROUND

In recent years, recovery of lithium battery has achieved rapid development. A ternary precursor and a lithium salt can be prepared from waste ternary lithium battery through cell-disassembling (also known as shredding, pretreating), leaching, extracting, regenerating, co-precipitating and synthesizing, with sodium sulfate as a side product. This method for recovery has achieved better economic benefits and formed a larger scale.

At present, in this method for recovery, the metal components in the battery powder are generally dissolved by acid leaching method in the leaching stage. There are two disadvantages in this treatment method. First, in the subsequent removal of copper, iron and aluminum, the aluminum is present in the form of waste residue, which is failed to be used reasonably; moreover, the entrainment of waste residue causes loss of a large amount of valuable metals, resulting in a low recovery rate of valuable metals. Second, multi-stage extraction is required to separate metals, resulting in a larger amount of waste water, a long process flow, and a high cost. Therefore, it is necessary to find a new method for recovering waste lithium battery materials to improve the recovery rate of valuable metals, while reducing the amount of wastewater in the recovery process and reducing the cost of recovery.

### SUMMARY

The present invention aims to solve the technical problems existing in the prior art, and provides a method for recovering waste lithium battery materials, which can realize non-extraction recovery of valuable metals from waste lithium battery materials and improve the recovery rate of valuable metals.

The above-mentioned technical purpose of the present invention is achieved through the following technical solutions.

A method for recovering waste lithium battery materials comprises the following steps:
(1) performing cell-disassembling on a waste lithium battery to obtain battery powder, ammonia leaching the obtained battery powder to obtain a mixture, and subjecting the mixture to solid-liquid separation to obtain a leached solution and a filter residue;
(2) adding a fluorine-phosphorus precipitating agent to the leached solution obtained in step (1) to obtain a mixture, and subjecting the mixture to solid-liquid separation to obtain a filtrate with fluorine-phosphorus residue removed;
(3) subjecting the filtrate obtained in step (2) to ammonia distillation, subjecting a mixture obtained after the ammonia distillation to solid-liquid separation to obtain a filtrate and a filter residue containing basic copper carbonate and lithium carbonate;
(4) washing the filter residue obtained in step (3) with water, and separating the basic copper carbonate to obtain a washing water containing lithium carbonate; and
(5) reducing and calcining the filter residue obtained in step (1), washing the calcined residue, adding the washing water obtained in step (4) to the residue to collect lithium by water leaching, and filtering a mixture after the water leaching to obtain a filtrate after collection of lithium.

Preferably, the filter residue obtained in step (1) is subjected to alkali leaching treatment before the reducing and calcining.

Preferably, the method for recovering waste lithium battery materials further comprises the following step: (6) adding alkali to the filtrate obtained in step (3) to adjust the pH to be alkaline, and filtering an alkaline mixture to obtain a filtrate and a filter residue containing nickel, cobalt, and manganese.

Preferably, the method for recovering waste lithium battery materials further comprises the following step: adding acid to the filtrate obtained in step (6) to adjust the pH to be acidic to obtain an aluminum hydroxide precipitate.

Preferably, the method for recovering waste lithium battery materials further comprises the following step: mixing the filter residue obtained in step (6) with the filtrate obtained in step (5) for acid leaching for synthesis of ternary materials.

Preferably, in step (1), the temperature of the ammonia leaching is 50-80° C., and the duration of the ammonia leaching is 1-10 hours.

Further preferably, in step (1), the temperature of the ammonia leaching is 60-75° C., and the duration of the ammonia leaching is 2-6 hours.

Preferably, in step (1), the ammonia solution used for the ammonia leaching is at least one of ammonium bicarbonate, ammonium carbonate and ammonium chloride.

Preferably, in step (1), the solid-liquid ratio of the ammonia leaching is (0.5-1.5):(2-3).

Further preferably, in step (1), the solid-liquid ratio of the ammonia leaching is 1:(2-3).

Preferably, in step (1), the concentration of the ammonia solution used in the ammonia leaching is ensured to be 3 wt %-20 wt %.

Further preferably, in step (1), the concentration of the ammonia solution used in the ammonia leaching is ensured to be 5 wt %-15 wt %.

Preferably, in step (1), air or oxygen is introduced into the ammonia solution used for the ammonia leaching while the ammonia leaching is performed.

Preferably, in step (2), the fluorine-phosphorus precipitating agent is at least one of calcium carbonate or calcium oxide.

Preferably, in step (3), the temperature of the ammonia distillation is 60-100° C.

Further preferably, in step (3), the temperature of the ammonia distillation is 90-100° C.

Preferably, in step (4), the solid-liquid ratio during the washing with water is (0.5-1.5):(3-10).

Further preferably, in step (4), the solid-liquid ratio during the washing with water is 1:(3-10).

Preferably, in step (5), the material used in the reducing and calcining is carbon powder, the mass ratio of the carbon powder to the filter residue is (3-10):1, and the temperature of the calcining is 500-1000° C.

Further preferably, in step (5), the material used in the reducing and calcining is carbon powder, the mass ratio of the carbon powder to the filter residue is (5-7):1, and the temperature of the calcining is 600-900° C.

Preferably, in step (6), alkali is added to adjust the pH to 9-13.

Further preferably, in step (6), alkali is added to adjust the pH to 10-12.

Preferably, adding acid to the filtrate obtained in step (6) to adjust the pH to be acidic refers to adding acid to adjust the pH to 2-5.

Further preferably, adding acid to the filtrate obtained in step (6) to adjust the pH to be acidic refers to adding acid to adjust the pH to 3-4.

The mechanism of the reaction in step (1) is as follows:

2Cu+O₂=2CuO

CuO+NH₃+NH₄HCO₃—Cu(NH₃)₂CO₃+H₂O

CuO+2NH₃+CO₂—Cu(NH₃)₂CO₃

4Al+6Cu(NH₃)₂CO₃+12H₂O+3O₂=6Cu²⁺+12NH₃+6CO₂+4[Al(OH)₆]³⁻

Li⁺+CO₃²⁻═Li₂CO₃

CoO+2NH₃+CO₂═Co(NH₃)₂CO₃

Both copper and aluminum are dissolved in ammonia solution.

The mechanism of the reaction in step (3) is as follows:

2Cu(NH₃)₂CO₃+H₂O═CuCO₃Cu(OH)₂↓+4NH₃↑+CO2↑

The mechanism of the reaction in step (5) is as follows:

4LiCoO₂+3C=2Li₂CO₃+4Co+CO₂↑

CO₂+C=2CO

2LiCoO₂+CO═Li₂CO₃+2CoO

C+O₂═CO₂

2LiCoO₂+CO₂=Li₂CO₃+Co₂O₃

Preferably, a method for recovering waste lithium battery materials comprises the following steps:
(1) disassembling a waste lithium battery material to obtain battery powder, ammonia leaching the obtained battery powder to obtain a mixture, and subjecting the mixture to solid-liquid separation to obtain a leached solution and a filter residue, wherein the disassembled battery powder mainly comprises lithium nickel cobalt manganese oxide, NCM oxide, and a small amount of aluminum and copper, with a main purpose of the ammonia leaching being to remove aluminum and copper, and the obtained filter residue can be further leached by adding sodium hydroxide to avoid residual aluminum;
(2) introducing calcium carbonate or calcium oxide into the leached solution obtained in (1), removing fluorine and phosphorus ions, and subjecting a mixture with fluorine and phosphorus ions removed to solid-liquid separation to obtain a filtrate and a filter residue, wherein the filter residue is calcium residue and fluorine-phosphorus residue;
(3) subjecting the filtrate obtained in step (2) to ammonia distillation, subjecting a mixture obtained after the ammonia distillation to solid-liquid separation to obtain a filtrate and a filter residue, wherein the filter residue is basic copper carbonate, lithium carbonate, a small amount of nickel-cobalt-manganese hydroxide and nickel-cobalt-manganese carbonate;
(4) washing the filter residue obtained in (3) with water, and separating the basic copper carbonate to obtain a washing water containing lithium carbonate;
(5) reducing and calcining the filter residue obtained in (1), adding the washing water obtained in (4) to the calcined residue to collect lithium by water leaching, and filtering a mixture after the water leaching to obtain a filtrate after collection of lithium, wherein the filter residue obtained in (1) comprises cathode powder lithium nickel cobalt manganese oxide and graphite;
(6) adding alkali to the filtrate obtained in (3) to adjust the pH to further recover nickel, cobalt and manganese, and filtering an obtained mixture to obtain a filtrate and a filter residue containing nickel, cobalt and manganese;
(7) adding acid to the filtrate obtained in (6) to adjust pH to precipitate aluminum hydroxide for electrolysis of aluminum; and
(8) mixing the filter residue obtained in (6) and the filtrate obtained in (5) to prepare a slurry, and acid leaching the slurry for the synthesis of ternary materials.

The present invention has the following beneficial effects.

The present invention provides a method for recovering waste lithium battery materials, comprising preferentially dissolving copper and aluminum in battery powder, removing fluorine and phosphorus, preparing basic copper carbonate and aluminum hydroxide, which are recovered and reasonably applied to the back end, recovering lithium from the filter residue by water leaching method, and then leaching metal elements of nickel, cobalt and manganese for the synthesis of ternary materials directly. The recovery rate of nickel, cobalt and manganese from waste lithium battery materials is not less than 99%, for example, 99.5%. This method for recovery is safe, low-cost and free of metal residue, and it can realize non-extraction recovery of valuable metals from waste lithium battery materials, and improve the recovery rate of valuable metals.

### BRIEF DESCRIPTION OF DRAWINGS

FIG. 1 is the schematic diagram of the process flow of Example 1 of the present invention.

### DETAILED DESCRIPTION

The present invention will be further described below with reference to specific examples.

### Example 1

A method for recovering waste lithium battery material comprised the following steps:

(1) A waste lithium battery was cell-disassembled to obtain 100 kg of powder material, the powder material was mixed with 300 L of 8% aqueous ammonia, and the mixture was heated up to 60° C. The ammonia concentration was detected and ammonium bicarbonate was replenished every half an hour to ensure that the ammonia concentration was not less than 8%. Meanwhile, air was introduced into the ammonia solution to react continuously for 4 hours, and the reacted mixture was filtered to obtain a leached solution and a filter residue.

(2) 6 kg calcium carbonate was added to the leached solution obtained in step (1) to remove impurities, and the mixture was filtered to obtain a residue containing calcium, fluorine and phosphorus and a filtrate.

(3) The filtrate obtained in step (2) was heated to 92° C. to undergo ammonia distillation, and the resulting mixture was subjected to solid-liquid separation to obtain a filtrate and 13 kg of filter residue containing basic copper carbonate and lithium carbonate.

(4) The filter residue obtained in step (3) was washed by adding 52 kg of water, and basic copper carbonate was separated to obtain a washing water containing lithium carbonate.

(5) 90 kg of the filter residue obtained in step (1) was taken and washed by adding deionized water, and then the mixture was filtered. The obtained filter residue was added with 450 kg of activated carbon, the mixture was calcined at 750° C. for 2 hours and then added with 410 L of water and the lithium-containing washing water obtained in step (4). The resulting mixture was heated up to 95° C. and filtered to obtain a filtrate and 14.2 kg of lithium carbonate monohydrate.

(6) Sodium hydroxide was added to the filtrate obtained in step (3) to adjust the pH to 12, and then the mixture was subjected to filter pressing and washed to obtain a filtrate and 3.2 kg of filter residue containing nickel-cobalt-manganese hydroxide.

(7) Sulfuric acid was added to the filtrate obtained in step (6) to adjust pH to 3.5, and then the mixture was subjected to filter pressing and washed to obtain an aluminum hydroxide precipitate.

(8) The filter residue obtained in step (6) and the filtrate obtained in step (5) were added with water in a solid-liquid ratio of 1:3 to prepare slurry, the slurry was added with sulfuric acid and hydrogen peroxide for dissolution, and then the mixture was filtered to obtain a ternary solution for synthesis of ternary material.

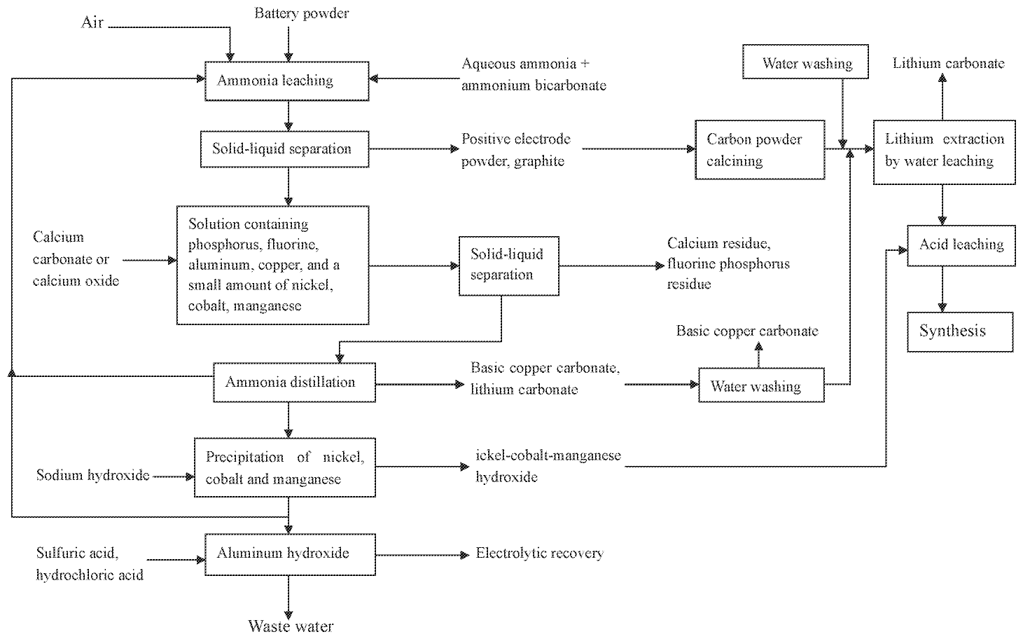

FIG. 1 was the process flow diagram of Example 1. In FIG. 1, the boxes represented the processing steps, the texts without boxes represented the obtained substances or the added substances, and the polygons represented multi-component mixtures, such as the leached solution obtained by ammonia leaching the battery powder.

### Example 2

A method for recovering waste lithium battery material comprised the following steps:

(1) A waste lithium battery was cell-disassembled to obtain 100 kg of powder material, the powder material was mixed with 600 L of 3% aqueous ammonia, and the mixture was heated up to 50° C. The ammonia concentration was detected and ammonium bicarbonate was replenished every half an hour to ensure that the ammonia concentration was not less than 3%. Meanwhile, oxygen was introduced into the ammonia solution to react continuously for 10 hours, and the reacted mixture was filtered to obtain a leached solution and a filter residue.

(2) 6 kg calcium oxide was added to the leached solution obtained in step (1) to remove impurities, and the mixture was filtered to obtain a residue containing calcium, fluorine and phosphorus and a filtrate.

(3) The filtrate obtained in step (2) was heated to 60° C. to undergo ammonia distillation, and the resulting mixture was subjected to solid-liquid separation to obtain a filtrate and 13 kg of filter residue containing basic copper carbonate and lithium carbonate.

(4) The filter residue obtained in step (3) was washed by adding 39 kg of water, and basic copper carbonate was separated to obtain a washing water containing lithium carbonate.

(5) 90 kg of the filter residue obtained in step (1) was taken and washed by adding deionized water, and then the mixture was filtered. The obtained filter residue was added with 270 kg of activated carbon, the mixture was calcined at 500° C. for 2 hours and then added with 410 L of water and the lithium-containing washing water obtained in step (4). The resulting mixture was heated up to 95° C. and filtered to obtain a filtrate and 14.2 kg of lithium carbonate monohydrate.

(6) Sodium hydroxide was added to the filtrate obtained in step (3) to adjust the pH to 9, and then the mixture was subjected to filter pressing and washed to obtain a filtrate and 3.2 kg of filter residue containing nickel-cobalt-manganese hydroxide.

(7) Sulfuric acid was added to the filtrate obtained in step (6) to adjust pH to 2, and then the mixture was subjected to filter pressing and washed to obtain an aluminum hydroxide precipitate.

(8) The filter residue obtained in step (6) and the filtrate obtained in step (5) were added with water in a solid-liquid ratio of 1:3 to prepare slurry, the slurry was added with sulfuric acid and hydrogen peroxide for dissolution, and then the mixture was filtered to obtain a ternary solution for synthesis of ternary material.

### Example 3

A method for recovering waste lithium battery material comprised the following steps:

(1) A waste lithium battery was cell-disassembled to obtain 100 kg of powder material, the powder material was mixed with 400 L of 20% aqueous ammonia, and the mixture was heated up to 80° C. The ammonia concentration was detected and ammonium bicarbonate was replenished every half an hour to ensure that the ammonia concentration was not less than 20%. Meanwhile, air was introduced into the ammonia solution to react continuously for 1 hours, and the reacted mixture was filtered to obtain a leached solution and a filter residue.

(2) 6 kg calcium oxide was added to the leached solution obtained in step (1) to remove impurities, and the mixture was filtered to obtain a residue containing calcium, fluorine and phosphorus and a filtrate.

(3) The filtrate obtained in step (2) was heated to 100° C. to undergo ammonia distillation, and the resulting mixture was subjected to solid-liquid separation to obtain a filtrate and 13 kg of filter residue containing basic copper carbonate and lithium carbonate.

(4) The filter residue obtained in step (3) was washed by adding 130 kg of water, and basic copper carbonate was separated to obtain a washing water containing lithium carbonate.

(5) 90 kg of the filter residue obtained in step (1) was taken and washed by adding deionized water, and then the mixture was filtered. The obtained filter residue was added with 900 kg of activated carbon, the mixture was calcined at 1000° C. for 2 hours and then added with 410 L of water and the lithium-containing washing water obtained in step (4). The resulting mixture was heated up to 95° C. and filtered to obtain a filtrate and 14.2 kg of lithium carbonate monohydrate.

(6) Sodium hydroxide was added to the filtrate obtained in step (3) to adjust the pH to 13, and then the mixture was subjected to filter pressing and washed to obtain a filtrate and 3.2 kg of filter residue containing nickel-cobalt-manganese hydroxide.

(7) Sulfuric acid was added to the filtrate obtained in step (6) to adjust pH to 5, and then the mixture was subjected to filter pressing and washed to obtain an aluminum hydroxide precipitate.

(8) The filter residue obtained in step (6) and the filtrate obtained in step (5) were added with water in a solid-liquid ratio of 1:3 to prepare slurry, the slurry was added with sulfuric acid and hydrogen peroxide for dissolution, and then the mixture was filtered to obtain a ternary solution for synthesis of ternary material.

### Comparative Example 1

A method for recovering waste lithium battery material comprised the following steps:

(1) A waste lithium battery was cell-disassembled to obtain 100 kg of powder material, the powder material was leached by acid to obtain a leached solution and a carbon black residue.

(2) Iron powder was added to the leached solution obtained in step (1) to reduce the leached solution to obtain sponge copper and a solution after copper removal.

(3) First, hydrogen peroxide was added to the solution after copper removal obtained in step (2) to react, then calcium carbonate was added to the mixture, and sulfuric acid was added to the mixture to adjust the pH to 3.5 to precipitate iron and aluminum to obtain a filtrate after removal of aluminum.

(4) The filtrate obtained in step (3) was extracted to obtain a solution of nickel-cobalt-manganese sulfate and a raffinate, the solution of nickel-cobalt-manganese sulfate was co-precipitated to obtain a ternary precursor, then an alkaline solution was added to the raffinate, and the resulting mixture was filtered to obtain a filter residue, namely lithium carbonate.

### Test Example

In Example 1 and Comparative Example 1, waste lithium batteries of the same batch and model were used as the raw materials for recovery. The components of the powder materials obtained after the cell-disassembly of the waste lithium batteries were as shown in Table 1:

TABLE 1
Elemental components of powder materials

| | | | | | Other |
|---|---|---|---|---|---|
| | NiCoMn | Cu | Al | Li | components |
| Content (%) | 22 | 7 | 9 | 3 | 59 |

The consumption of auxiliary materials in Example 1 and Comparative Example 1 was detected, and the results were shown in Table 2:

TABLE 2
Auxiliary material consumption (units are in terms of kg)

| | Example 1 | Comparative Example 1 |
|---|---|---|
| Carbon powder | 450 | 1 |
| Aqueous ammonia | 3 | 0 |
| Carbon ammonium | 3 | 0 |
| Sulfuric acid | 300 | 550 |
| Hydrogen peroxide | 15 | 30 |
| Iron powder | 0 | 8 |
| Ionic membrane alkali | 6 | 60 |
| Sodium carbonate | 0 | 6 |
| Extracting agent | 0 | 1.5 |

As can be seen from Table 2, comparing Example 1 with Comparative Example 1, in the present invention, sulfuric acid was saved by 45%, hydrogen peroxide was saved by 50%, ionic membrane alkali was saved by 90%, there was no extraction in the whole process, the technological process was shortened, and the consumption of carbon powder and ammonia was increased.

The waste water, waste gas and waste solid discharged in Example 1 and Comparative Example 1 were detected. The results were as shown in Table 3:

TABLE 3
Table of discharge of waste water, waste gas
and waste solid (units are in terms of kg)

| | | | Iron and | Fluorine and | |
|---|---|---|---|---|---|
| | | Waste | aluminum | phosphorus | Graphite |
| | Waste gas | water | residue | residue | residue |
| Example 1 | Uncounted | 500 | 0 | 60 | 30 |
| Comparative | Uncounted | 1000 | 320 | 60 | 30 |
| Example 1 | | | | | |

As can be seen from Table 3, comparing Example 1 with Comparative Example 1, in the present invention, the waste water was reduced by 50% (the main reason is that there was no extraction in the whole process), the main waste water produced by the present invention is the waste water after washing residue and precipitating a small amount of aluminum, and the aluminum hydroxide of the present invention was subsequently used for electrolysis of aluminum, whereas the dry weight of iron and aluminum residue in Comparative Example 1 was 16 kg (dry basis 0.05), which was generally treated as solid waste. The other residue amount was basically the same.

The recovery rate of valuable metals in Example 1 and Comparative Example 1 was detected. The results were as shown in Table 4:

TABLE 4
Recovery rate of valuable metal

| | NiCoMn (%) | Cu (%) | Al (%) | Li (%) |
|---|---|---|---|---|
| Example 1 | 99.5 | 99 | 96 | 91 |
| Comparative | 95.6 | 98 | 0 | 91 |
| Example 1 | | | | |

As can be seen from Table 4, comparing Example 1 with Comparative Example 1, the recovery rate of nickel-cobalt-manganese of the present invention reached 99.5%, which was 3.9% higher than that of Comparative Example 1. In the present invention, the metal loss was mainly concentrated in the metal loss in the graphite residue. Compared with Comparative Example 1, the product was mainly recoverable aluminum hydroxide with a small amount of residue, and the metal entrainment can be reduced by acid washing. In the Comparative Example 1, the iron and aluminum residue was of a large amount, leading to serious metal loss. Moreover, there was no extraction in the present invention, reducing a large amount of waste water and metal loss.

The level of effect achieved by Examples 2-3 was similar to that of Example 1.

The above-mentioned examples are preferred embodiments of the present invention, but the embodiments of the present invention are not limited by the above-mentioned examples, and any other changes, modifications, substitutions, combinations, and simplification made without departing from the spirit and principle of the present invention shall be equivalent replacement modes, which are all included in the protection scope of the present invention.

1. A method for recovering waste lithium battery materials, comprising the following steps:
(1) performing cell-disassembling on a waste lithium battery to obtain battery powder, ammonia leaching the obtained battery powder to obtain a mixture, and subjecting the mixture to solid-liquid separation to obtain a leached solution and a filter residue;
(2) adding a fluorine-phosphorus precipitating agent to the leached solution obtained in step (1) to obtain a mixture, and subjecting the mixture to solid-liquid separation to obtain a filtrate with fluorine-phosphorus residue removed;
(3) subjecting the filtrate obtained in step (2) to ammonia distillation, subjecting a mixture obtained after the ammonia distillation to solid-liquid separation to obtain a filtrate and a filter residue containing basic copper carbonate and lithium carbonate;
(4) washing the filter residue obtained in step (3) with water, and separating the basic copper carbonate to obtain a washing water containing lithium carbonate; and
(5) reducing and calcining the filter residue obtained in step (1), washing the calcined residue, adding the washing water obtained in step (4) to the residue to collect lithium by water leaching, and filtering a mixture after the water leaching to obtain a filtrate after collection of lithium.

2. The method for recovering waste lithium battery materials according to claim 1, further comprising the following steps: (6) adding alkali to the filtrate obtained in step (3) to adjust the pH to be alkaline, and filtering an alkaline mixture to obtain a filtrate and a filter residue containing nickel, cobalt, and manganese.

3. The method for recovering waste lithium battery materials according to claim 2, further comprising the following steps: adding acid to the filtrate obtained in step (6) to adjust the pH to be acidic to obtain an aluminum hydroxide precipitate.

4. The method for recovering waste lithium battery materials according to claim 2, further comprising the following steps: mixing the filter residue obtained in step (6) with the filtrate obtained in step (5) for acid leaching for synthesis of ternary materials.

5. The method for recovering waste lithium battery materials according to claim 1, wherein in step (1), the temperature of the ammonia leaching is 50-80° C., and the duration of the ammonia leaching is 1-10 hours.

6. The method for recovering waste lithium battery materials according to claim 1, wherein in step (1), the solid-liquid ratio of the ammonia leaching is (0.5-1.5):(2-3).

7. The method for recovering waste lithium battery materials according to claim 1, wherein in step (1), the concentration of the ammonia solution used in the ammonia leaching is ensured to be 3 wt %-20 wt %.

8. The method for recovering waste lithium battery materials according to claim 1, wherein in step (2), the fluorine-phosphorus precipitating agent is at least one of calcium carbonate or calcium oxide.

9. The method for recovering waste lithium battery materials according to claim 1, wherein in step (5), the material used in the reducing and calcining is carbon powder, the mass ratio of the carbon powder to the filter residue is (3-10):1, and the temperature of the calcining is 500-1000° C.

10. The method for recovering waste lithium battery materials according to claim 2, wherein in step (6), alkali is added to adjust the pH to 9-13.
